(19) United States
(12) Patent Application Publication
(10) Pub. No.: US 2022/0264783 A1
(43) Pub. Date: Aug. 25, 2022

(54) SYSTEM AND METHOD FOR ADJUSTING A HEIGHT LIMIT OF A ROW CLEANER OF A ROW UNIT OF AN AGRICULTURAL IMPLEMENT

(71) Applicant: CNH Industrial America LLC, New Holland, PA (US)

(72) Inventors: Chad M. Johnson, Arlington Heights, IL (US); Trevor Stanhope, Oak Lawn, IL (US); Michael Christopher Conboy, Chicago, IL (US)

(21) Appl. No.: 17/179,575

(22) Filed: Feb. 19, 2021

(51) Int. Cl. A01B 63/00; A01B 71/08

(52) U.S. Cl. CPC A01B 63/008; A01B 71/08

(57) ABSTRACT

An agricultural implement may include a frame and a row unit supported by the frame, where the row unit works a field as the implement is moved across the field. The row unit includes a first frame member coupled to a support structure of the row unit, a second frame member rotatable relative to the first frame member, and at least one cleaning wheel rotatable relative to the second frame member. Additionally, the row unit includes a depth stop member movably coupled to the first frame member, where the depth stop member is configured to set a lower height limit for the at least one cleaning wheel, with the second frame member being configured to abut against the depth stop member when the at least one cleaning wheel is disposed at the lower height limit.

### FIELD OF THE INVENTION

The present disclosure relates generally to agricultural implements and, more particularly, to systems and methods for automatically adjusting a height limit of a row cleaner of an agricultural implement.

### BACKGROUND OF THE INVENTION

Modern farming practices strive to increase yields of agricultural fields. In this respect, certain agricultural implements, such as seed-planting implements, are towed behind a tractor or other work vehicle for planting. A seed-planting implement typically includes one or more ground engaging assemblies configured to work the soil as the implement is moved across a field. For example, in certain configurations, the implement may include one or more row cleaners that move residue and break up or sweep away clods from the path of subsequent ground engaging assemblies, such as one or more opening assemblies that form a trench or furrow within the soil for receiving seeds as the implement is moved across the field. Furthermore, the implement may also include one or more closing assemblies that close the furrow over seeds while the implement is moved across the field. In this regard, the function(s) of the ground engaging tool(s) requires or relies upon movement of the field materials, such as soil, crop residue, and/or clods, relative to the assemblies.

Typically, the ground engaging assemblies are configured to work the soil in a specific way. For example, when the row cleaners are operating with the correct engagement with the field, there is little to no residue left behind the row cleaners and very little soil is moved by the row cleaners. If too much residue is left behind, the residue may be pushed into the trenches, causing poor seed-to-soil contact, which may affect yields or may cause problems with depth control for the gauge wheels. Similarly, depending on the moisture within the field, the engagement between the row cleaners and the field may vary. As such, the row cleaners may have adjustable height limit settings for adjusting the height that the row cleaners may operate relative to the ground so that the row cleaners have the proper engagement with a field. However, the height limit settings of row cleaners are usually adjusted manually, one row unit at a time, which is a time consuming process. Further, it may be necessary to adjust the height limit settings multiple times throughout operation of the implement, which multiplies the time for such height limit adjustment process. Consequently, reconfiguration of the implement for a different height limit setting may result in large delays in seed planting operations, thereby decreasing seed planting efficiency.

Accordingly, an improved system and method for automatically adjusting a height limit of a row cleaner of an agricultural implement would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a system for adjusting a height limit of a row cleaner of a row unit of an agricultural implement. The system may include a first frame member coupled to a support structure of a row unit of an agricultural implement, a second frame member rotatable relative to the first frame member, at least one cleaning wheel rotatable relative to the second frame member, and a depth stop member movably coupled to the first frame member. The depth stop member may be configured to set a lower height limit for the at least one cleaning wheel, with the second frame member being configured to abut against the depth stop member when the at least one cleaning wheel is disposed at the lower height limit. The system may further include an actuator controllable to move the depth stop member relative to the first frame member to adjust the lower height limit, and a controller configured to selectively control an operation of the actuator to set the lower height limit.

In another aspect, the present subject matter is directed to an agricultural implement including a frame and a row unit supported by the frame, where the row unit is configured to work a field as the implement is moved across the field. The row unit may include a first frame member coupled to a support structure of the row unit, a second frame member rotatable relative to the first frame member, at least one cleaning wheel rotatable relative to the second frame member, and a depth stop member movably coupled to the first frame member. The depth stop member is configured to set a lower height limit for the at least one cleaning wheel, with the second frame member being configured to abut against the depth stop member when the at least one cleaning wheel is disposed at the lower height limit.

In an additional aspect, the present subject matter is directed to a method for automatically adjusting a height limit of a row cleaner of a row unit of an agricultural implement, where the row cleaner includes a first frame member coupled to a support structure of the row unit, a second frame member rotatable relative to the first frame member, at least one cleaning wheel rotatable relative to the second frame member, and a depth stop member movably coupled to the first frame member. The method may include receiving, by one or more computing devices, an input associated with adjusting a lower height limit for the at least one cleaning wheel. The lower height limit is set by the depth stop member. Additionally, the method may include automatically controlling, with the one or more computing devices, an operation of an actuator to move the depth stop member based at least in part on the input to adjust the lower height limit for the at least one cleaning wheel.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of an agricultural implement in accordance with aspects of the present subject matter;

FIG. 2 illustrates a side view of one embodiment of a row unit suitable for use with an agricultural implement in accordance with aspects of the present subject matter, particularly illustrating a row cleaner and an adjustment assembly for use with the row cleaner;

FIG. 3 illustrates a perspective view of one embodiment of a depth stop member of the adjustment assembly shown in FIG. 2 in accordance with aspects of the present subject matter;

FIGS. 4A and 4B illustrate side views of the row cleaner shown in FIG. 2, particularly illustrating the row cleaner at a minimum lower height setting and a maximum lower height setting, respectively, in accordance with aspects of the present subject matter;

FIGS. 5A and 5B illustrate perspective views of the adjustment assembly shown in FIG. 2, particularly illustrating different embodiments of an actuator suitable for use within the adjustment assembly in accordance with aspects of the present subject matter;

FIGS. 6A and 6B illustrate side views of a variation of the adjustment assembly of the row cleaner shown in FIG. 2, particularly illustrating the row cleaner at a minimum lower height setting and a maximum lower height setting, respectively, in accordance with aspects of the present subject matter;

FIGS. 7A and 7B illustrate side views of another variation of the adjustment assembly of the row cleaner shown in FIG. 2, particularly illustrating the row cleaner at a minimum lower height setting and a maximum lower height setting, respectively, in accordance with aspects of the present subject matter;

FIG. 8 illustrates a schematic view of a system for automatically controlling a height limit of a row cleaner of a row unit of an agricultural implement in accordance with aspects of the present subject matter; and

FIG. 9 illustrates a flow diagram of one embodiment of a method for automatically adjusting a height limit of a row cleaner of an agricultural implement in accordance with aspects of the present subject matter.

Repeat use of reference characters in the present specification and drawings is intended to represent the same or analogous features or elements of the present technology.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to automatically adjusting a height limit of a row cleaner of an agricultural implement. Specifically, in several embodiments, an agricultural implement may include a plurality of row cleaners, where each row cleaner has at least one cleaning wheel configured to clear away residue and clods from a travel path of subsequent ground engaging tools (e.g., disc openers, seed dispensing tools, closing wheels, etc.). In one example, the cleaning wheel(s) of each row cleaner may be supported by a wheel support frame member rotatably coupled to a support frame member that is, in turn, coupled to a frame of the row unit or of the implement. In accordance with aspects of the present subject matter, the row cleaners may have an adjustable lower height limit to control the maximum engagement between the cleaning wheel(s) and a surface of the field. Particularly, each row cleaner may have a depth stop member against which the wheel support frame member abuts when the cleaning wheel(s) is at the lower height limit. More particularly, the depth stop member may be moved relative to the support frame member to adjust the lower height limit. An actuator of the row cleaner may be selectively controlled to move (e.g., rotate or translate) the depth stop member to adjust the lower height limit of the cleaning wheel(s). As such, the lower height limit of the row cleaners may be adjusted quickly. Additionally, in some embodiments, the actuator may be actively controlled to adjust the lower depth limit of the row cleaners for different field conditions, for example, depending on the residue coverage/size and/or moisture content within the field.

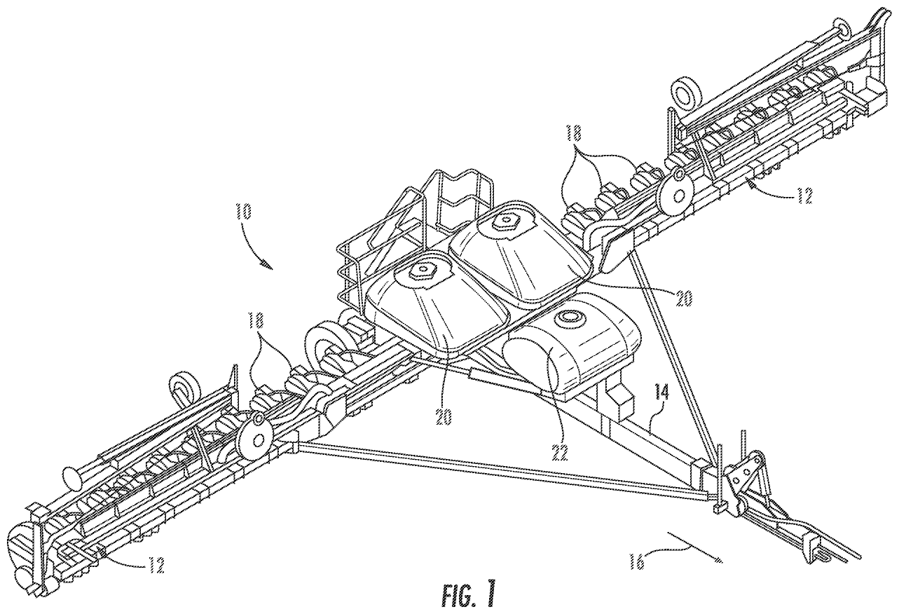

Referring now to the drawings, FIG. 1 illustrates a perspective view of one embodiment of an agricultural implement 10 in accordance with aspects of the present subject matter. It should be appreciated that, although the agricultural implement 10 illustrated herein corresponds to a seed-planting implement or planter, the implement 10 may generally correspond to any suitable equipment or implement having tools configured to engage the soil within a field, such as a tillage implement, a planter, and/or the like.

As shown in FIG. 1, the implement 10 may include a laterally extending toolbar or frame assembly 12 (e.g., including laterally extending, left and right toolbar sections) connected at its middle to a forwardly extending tow bar 14 to allow the implement 10 to be towed by a work vehicle (not shown), such as an agricultural tractor, in a direction of travel (e.g., as indicated by arrow 16 in FIG. 1). The toolbar 12 may generally be configured to support a plurality of seed planting units (or row units) 18. As is generally understood, each row unit 18 may be configured to deposit seeds at a desired depth beneath the soil surface and at a desired seed spacing as the implement 10 is being towed by the work vehicle, thereby establishing rows of planted seeds. In some embodiments, the bulk of the seeds to be planted may be stored in one or more hoppers or seed tanks 20. Thus, as seeds are planted by the row units 18, a pneumatic distribution system may distribute additional seeds from the seed tanks 20 to the individual row units 18. Additionally, one or more fluid tanks 22 may store agricultural fluids, such as insecticides, herbicides, fungicides, fertilizers, and/or the like.

It should be appreciated that, in general, the implement 10 may include any number of row units 18, such as six, eight, twelve, sixteen, twenty-four, thirty-two, or thirty-six row units. In addition, it should be appreciated that the lateral spacing between row units 18 may be selected based on the type of crop being planted. For example, the row units 18 may be spaced approximately thirty inches from one another for planting corn, and approximately fifteen inches from one another for planting soybeans.

It should also be appreciated that the configuration of the seed-planting implement 10 described above and shown in FIG. 1 is provided only to place the present subject matter in an exemplary field of use. Thus, it should be appreciated that the present subject matter may be readily adaptable to any manner of implement configuration. For example, the implement 10 may instead be configured as a tillage implement having one or more ground engaging assemblies capable of experiencing material accumulation, such as one or more tillage assemblies having disc harrows or rolling baskets.

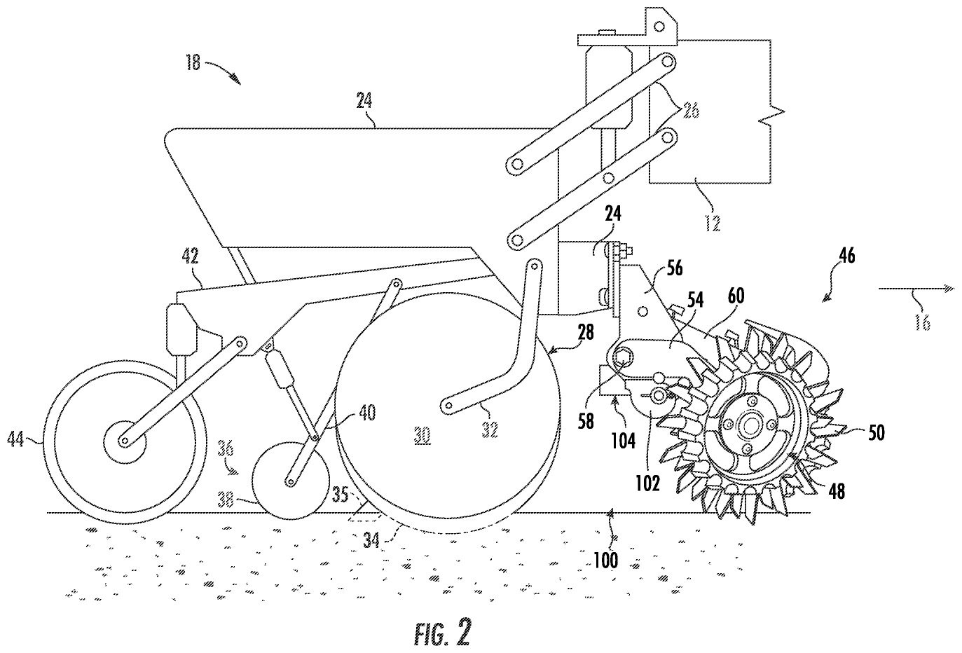

Referring now to FIG. 2, a side view of one embodiment of a row unit 18 is illustrated in accordance with aspects of the present subject matter. As shown, the row unit 18 may include a frame 24 adjustably coupled to the toolbar 12 by links 26. For example, one end of each link 26 may be pivotably coupled to the frame 24, while an opposed end of each link 26 may be pivotably coupled to the toolbar 12. In one embodiment, the links 26 may be parallel. However, it should be appreciated that, in alternative embodiments, the row unit 18 may be coupled to the toolbar 12 in any other suitable manner.

As shown in FIG. 2, the row unit 18 also includes a furrow opening assembly 28. For example, in one embodiment, the furrow opening assembly 28 may include a gauge wheel 30 operatively coupled to the frame 24 of the row unit 18 via a support arm 32. Furthermore, the opening assembly 28 may also include disc openers 34 (only one of which is shown) configured to excavate a furrow or trench in the soil. As is generally understood, the gauge wheel 30 may be configured to engage the top surface of the soil as the implement 10 is moved across the field. In this regard, the height of the disc opener(s) 34 may be adjusted with respect to the position of the gauge wheel 30 to set the desired depth of the furrow being excavated. A delivery tube 35 may be configured to deposit seeds, fertilizer, and/or the like in the trench formed by the disc openers 34. In some embodiments, the delivery tube 35 is positioned at least partially between the gauge wheels 30 and/or between the disc openers 34.

Moreover, as shown, the row unit 18 may include a furrow closing assembly 36. Specifically, in several embodiments, the furrow closing assembly 36 may include a pair of closing discs 38 (only one of which is shown) positioned relative to each other in a manner that permits soil to flow between the discs 38 as the implement 10 is being moved across the field. As such, the closing discs 38 may be configured to close the furrow after seeds have been deposited therein, such as by pushing the excavated soil into the furrow. Furthermore, the furrow closing assembly 36 may include a support arm 40 configured to adjustably couple the closing discs 38 to the frame 24. For example, one end of the support arm 40 may be pivotably coupled to the closing discs 38, while an opposed end of the support arm 40 may be pivotably coupled to a chassis arm 42, which is, in turn, coupled to the frame 24. However, it should be appreciated that, in alternative embodiments, the closing discs 38 may be coupled to the frame 24 in any other suitable manner. Furthermore, it should be appreciated that, in alternative embodiments, the furrow closing assembly 36 may include any other suitable number of closing discs 38, such as one closing disc 38 or three or more closing discs 38. Additionally, the furrow closing assembly 36 may include a press wheel 44 configured to roll over the closed furrow to firm the soil over the seed and promote favorable seed-to-soil contact.

Additionally, as shown in FIG. 2, the row unit 18 may include a row cleaning device or row cleaner 46 positioned at the forward end of the row unit 18 relative to the direction of travel 16. In this regard, the row cleaner 46 may be configured to adjust the surface cleanliness of the field. For instance, the row cleaner 46 may break up and/or sweep away residue, dirt clods, and/or the like from the travel path of components aft of the row cleaner 46 (e.g., disc openers 34), such as before the furrow is formed in the soil. For example, in one embodiment, the row cleaner 46 may include a pair of cleaning wheels 48 (only one of which is shown in FIG. 2), with each wheel 48 having a plurality of tillage points or fingers 50. As such, the wheels 48 may be configured to roll relative to the soil as the implement 10 is moved across the field such that the fingers 50 break up and/or sweep away residue and dirt clods.

More particularly, in one embodiment, the cleaning wheel(s) 48 may be rotatably coupled to a wheel frame member 54, with the wheel frame member 54 being rotatably coupled to a support frame member 56 about a pivot point 58. For example, one end of the wheel frame member 54 may be configured to support the wheel(s) 48 for rotation relative thereto, while an opposed end of the wheel frame member 54 may be pivotably coupled to the support frame member 56. The support frame member 56 is further coupled or fixed to the support structure or frame 24 of the row unit 18 to support the cleaning wheel(s) 48 relative to the frame 24. The row cleaner 46 may further include a biasing member 60 (e.g., one or more springs, pneumatic or hydraulic cylinders, etc.) for biasing the cleaning wheel(s) 48 downwards towards engagement with a field surface. It should be appreciated that, in alternative embodiments, the cleaning wheel(s) 48 may be supported relative to the frame 24 in any other suitable manner. For instance, the cleaning wheel(s) 48 may be rotatably coupled to a wheel support arm, with the wheel support arm being coupled to the support frame member 56 by a linkage. The linkage may include a wheel frame member and a linking member. The wheel frame member may extend between a first end and a second end, where the first end of the wheel frame member is rotatably coupled to the support frame member 56 and the second end of the wheel frame member is rotatably coupled to the wheel support arm. Similarly, the linking member may extend between a first end and a second end, where the first end of the linking member is rotatably coupled to the support frame member 56 and the second end of the linking member is rotatably coupled to the wheel support arm. As such, the support frame member 56, the wheel frame member, the linking member, and the wheel support arm may form a four-bar linkage. Furthermore, it should be appreciated that, in alternative embodiments, the row cleaner 46 may include any other suitable number of cleaning wheels 48 and/or may be configured in any other suitable manner.

In accordance with aspects of the present subject matter, the row cleaner 46 may further include an adjustment assembly 100 for adjusting a lower height limit for the cleaning wheel(s) 48. Particularly, the adjustment assembly 100 includes a depth stop member 102 and an actuator 104. In general, the depth stop member 102 is movably supported relative to or coupled to the support frame member 56 at a position below the wheel frame member 54 to vary the portion of the depth stop member 102 that the wheel frame member 54 is configured to engage or abut against and thus, vary the amount that the wheel frame member 54 is configured to pivot downward about the pivot point 58 relative to the support frame member 56. Specifically, the movement of the depth stop member 102 varies the amount that the wheel frame member 54 is allowed to pivot downward before coming into contact with the depth stop member 102, which, in turn, varies the positioning of the cleaning wheel(s) 48 along a vertical direction V1 and, thus, adjusts a lower height limit for the cleaning wheel(s) 48. As shown in the illustrated embodiment, a lower surface or portion of the wheel frame member 54 between the pivot point 58 and the wheel(s) 48 is generally configured to abut against a profile of the depth stop member 102 (e.g., due to the biasing force applied by the bias member 60 and/or gravity) when the wheel(s) 48 at the lower height limit. The wheel(s) 48 may be allowed to move upward away from the lower height limit (e.g., against the biasing force applied by the bias member 60), for example, if the wheel(s) 48 encounter a rock or other obstruction during operation. Additionally, as will be described in greater detail below, the actuator 104 of the adjustment assembly 100 may be selectively controllable to move the depth stop member 102 relative to the support frame member 56 to adjust the lower height limit for the row cleaner 46.

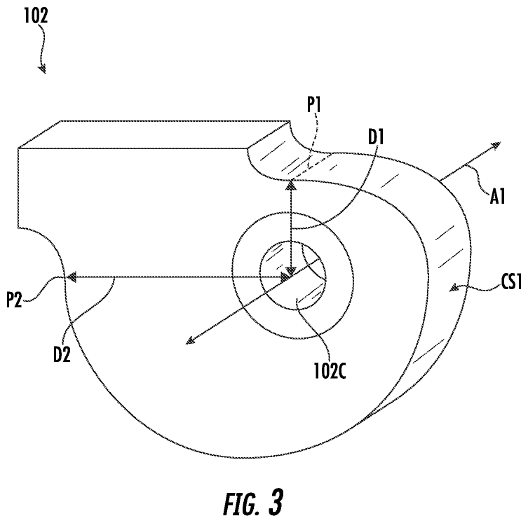

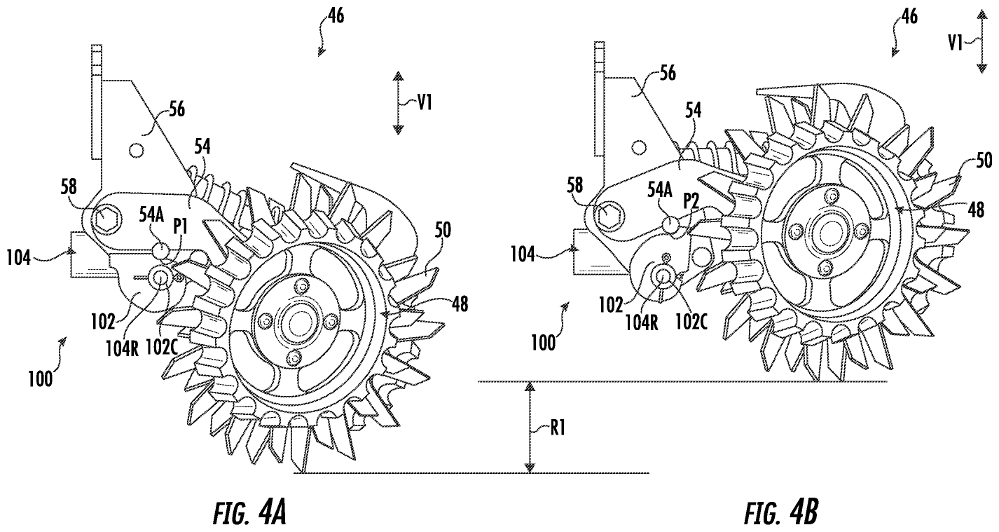

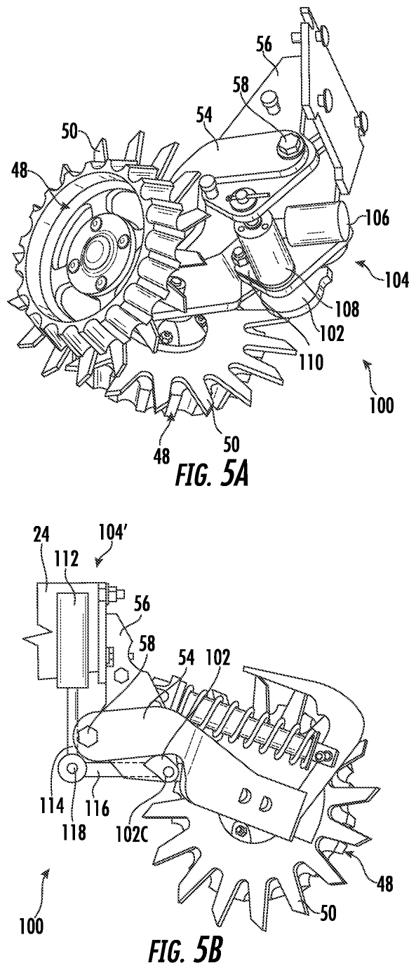

Referring now to FIGS. 3-5B, various view of embodiments of an adjustment assembly 100 configured for use with a row cleaner (e.g., the row cleaner 46 shown in FIG. 2) are illustrated in accordance with aspects of the present subject matter. Specifically, FIG. 3 illustrates a perspective view of one embodiment of the depth stop member 102 of the adjustment assembly 100 shown in FIG. 2. FIGS. 4A and 4B illustrate side views of the row cleaner shown in FIG. 2, particularly illustrating the row cleaner at a minimum lower height setting and a maximum lower height setting, respectively. Additionally, FIGS. 5A and 5B illustrate perspective views of the adjustment assembly shown in FIG. 2, particularly illustrating different embodiments of an actuator suitable for use within the adjustment assembly.

As shown in FIG. 3, in one embodiment, the depth stop member 102 is configured as a cam. More particularly, the depth stop member 102 has a cam profile or contact surface CS1 against which the wheel frame member 54 (FIG. 2) is configured to abut when the cleaning wheel(s) 48 (FIG. 2) is disposed at the lower height limit. The contact surface CS1 extends generally parallel to a rotational axis A1 of the depth stop member 102 about which the depth stop member 102 rotates relative to the support frame member 56 (FIG. 2). The rotational axis A1 may be defined by or at a central opening 102C for receiving a portion of the actuator 104 (FIG. 2). The contact surface CS1 has a varying distance from the rotational axis A1 which may be used to adjust the lower height limit. For instance, the depth stop member 102 is rotatable between a first rotational position (FIG. 4A) where a first portion P1 of the contact surface CS1 may be abutted against by the wheel frame member 54 (FIG. 2) and a second rotational position (FIG. 4B) where a second portion P2 of the contact surface CS1 may be abutted against by the wheel frame member 54 (FIG. 2). The first portion P1 of the contact surface CS1 extends a first distance D1 from the rotational axis A1 and the second portion P2 of the contact surface CS1 extends a second distance D2 from the rotational axis A1, where the first distance D1 differs from the second distance D2. Particularly, in some embodiments, the first distance D1 is smaller than the second distance D2. For instance, the distance between the contact surface CS1 and the rotational axis generally increases from the first portion P1 to the second portion P2. For example, in one embodiment, the distance between the contact surface CS1 and the rotational axis continuously increases from the first portion P1 to the second portion P2.

Generally, the larger the distance between the wheel frame member 54 and the rotational axis A1 of the depth stop member 102 (e.g., the distance between the contact surface CS1 and the rotational axis A1), the greater the adjustment in the lower height limit. For instance, as the first portion P1 corresponds to the smallest distance D1 between the contact surface CS1 and the rotational axis A1, the first portion P1 also corresponds to the smallest distance between the wheel frame member 54 and the rotational axis A1. Thus, when the depth stop member 102 is in the first rotational position, the lower height limit is adjusted by the smallest amount, and the lower height limit is equal to a minimum lower height setting for the row cleaner 46. Similarly, as the second portion P2 corresponds to the largest distance D2 between the contact surface CS1 and the rotational axis A1, the second portion D2 also corresponds to the largest distance between the wheel frame member 54 and the rotational axis A1. Thus, when the depth stop member 102 is in the second rotational position, the lower height limit is adjusted by the largest amount, and the lower height limit is equal to a maximum lower height setting for the row cleaner 46.

For example, as shown in FIG. 4A, when the depth stop member 102 is rotated to the first rotational position and a lower portion 54A of the wheel frame member 54 abuts against the first portion P1 of the depth stop member 102, the cleaning wheel(s) 48 is at the minimum lower height setting along the vertical direction V1. Similarly, as shown in FIG. 4B, when the depth stop member 102 is rotated to the second rotational position and a lower portion 54A of the wheel frame member 54 abuts against the second portion P2 of the depth stop member 102, the cleaning wheel(s) 48 is at a maximum lower height setting along the vertical direction V1. As such, varying the rotational position of the depth stop member between the first and second rotational positions generally varies the lower height limit within a range R1 defined between the minimum and maximum lower height settings. It should be appreciated that same portion (e.g., the lower portion 54A) of the wheel frame member 54 abuts against the depth stop member 102 regardless of the rotational position of the depth stop member 102.

As indicated above, in several embodiments, the depth stop member 102 may be selectively rotatable by the actuator 104. In some embodiments, the actuator 104 is configured as a rotary actuator. For instance, in the embodiment shown in FIG. 5A, the actuator 104 includes a shaft 104R (FIGS. 4A and 4B), a motor 106, a gearbox 108, and a mounting bracket 110. The shaft 104R is rotated by the gearbox 108, which, in turn, is driven by the motor 106. A housing of the gearbox 108 is mounted to the support frame member 56 by the mounting bracket 110 such that the gearbox 108 transfers motion to the shaft 104R instead of the housing. The shaft 104R may be configured to be received within the central opening 102C (FIGS. 4A and 4B) of the depth stop member 102 or otherwise fixed to the depth stop member 102 such that the depth stop member 102 rotates with the shaft 104R about the axis A1 (FIG. 3). It should be appreciated that, in some embodiments, the motor 106 may instead be directly coupled to the shaft 104R to rotate the shaft 104R about the axis A1.

Alternatively, in some embodiments, the actuator 104 is configured as a linear actuator. For instance, in the embodiment shown in FIG. 5B, the actuator 104′ includes a cylinder 112 (e.g., hydraulic, pneumatic, etc.), a rod 114, and a linkage 116. One end of the rod 114 is received within the cylinder 112 and another end of the rod 114 is coupled to a first end of the linkage 116. A second end of the linkage 116 is received within the central opening 102C (FIGS. 4A and 4B) of the depth stop member 102 or otherwise fixed to the depth stop member 102. As the rod 114 is extended or retracted relative to the cylinder 112, the rod 114 pushes or pulls the first end of the linkage 116 to rotate the linkage 116 and, thus, the depth stop member 102, about the axis A1 (FIG. 3).

It should be appreciated that the examples of the actuator shown in FIGS. 5A and 5B should not be construed as limiting. Instead, it should be appreciated that the actuator may be configured as any suitable type of actuator for rotating the depth stop member 102′. It should further be appreciated that, as the depth stop member 102 is rotatably mounted to the support frame member 56 instead of the wheel support member 54, the actuator 104, 104′ may also be supported by a non-movable frame member (e.g., support frame member 56 or frame 24). One of ordinary skill in the art will appreciate that as the number of moving parts is reduced, the assembly and maintenance of the row unit 18 is simplified, the likelihood of unintended interference with other parts of the row unit 18 is reduced, and potential wear on the actuator 104, 104′ is reduced.

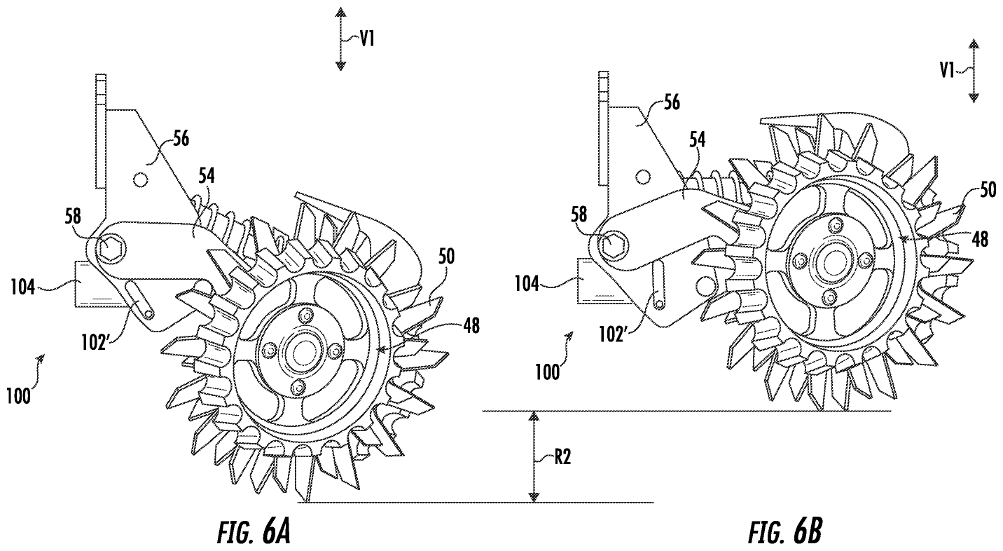

Referring now to FIGS. 6A and 6B, exemplary side views of a variation of the adjustment assembly of the row cleaner shown in FIG. 2 are illustrated. Particularly, in the embodiment shown, the adjustment assembly 100 is configured substantially similar to the adjustment assembly described above with reference to FIGS. 2-5B, except for the depth stop member. More particularly, the adjustment assembly 100 includes a depth stop member 102′ having a lever-like configuration as opposed to the cam-like configuration of the depth stop member 102 of FIGS. 2-5B. The depth stop member 102′ functions in essentially the same way as the depth stop member 102 described above with reference to FIGS. 2-5B. For instance, the depth stop member 102′ is rotatably supported relative to or coupled to the support frame member 56 at a position below the wheel frame member 54 to vary the amount that the wheel frame member 54 is allowed to pivot before coming into contact with the depth stop member 102′, which, in turn, varies the vertical positioning of the cleaning wheel(s) 48 and, thus, adjusts the lower height limit for the cleaning wheel(s) 48.

For instance, as shown in FIG. 6A, when the depth stop member 102′ is in a first rotational position and a lower portion or surface of the wheel frame member 54 abuts against the depth stop member 102′, the cleaning wheel(s) 48 is at a minimum lower height setting along the vertical direction V1. Similarly, as shown in FIG. 6B, when the depth stop member 102′ is rotated to a second rotational position and a lower portion of the wheel frame member 54 abuts against the depth stop member 102′, the cleaning wheel(s) 48 is at a maximum lower height setting along the vertical direction V1. As such, varying the rotational position of the depth stop member 102′ between the first and second rotational positions generally varies the lower height limit within a range R2 defined between the minimum and maximum lower height settings. It should be appreciated that the portion of the wheel frame member 54 that abuts against the depth stop member 102′ changes with rotation of the depth stop member 102′. For instance, the depth stop member 102′ contacts a portion of the wheel frame member 54 closer to the pivot point 58 when in the first rotational position than in the second rotational position.

Additionally, the actuator 104 of the adjustment assembly 100 may be selectively controllable to rotate the depth stop member 102′ relative to the support frame member 56 to adjust such lower height limit. As discussed above with reference to FIGS. 5A and 5B, it should be appreciated that the actuator 104 may be configured as any suitable type of actuator for rotating the depth stop member 102′, such as a rotary actuator, a linear actuator, and/or the like.

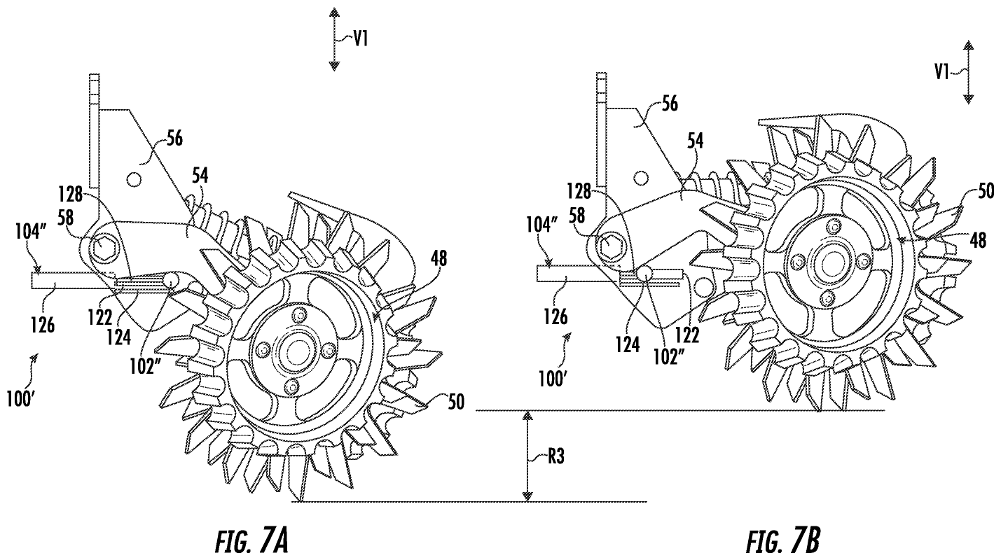

Referring now to FIGS. 7A and 7B, exemplary side views of another variation of the adjustment assembly of the row cleaner shown in FIG. 2 are illustrated. Particularly, in the embodiment shown, the adjustment assembly 100′ includes a depth stop member 102″ and an actuator 104″. The depth stop member 102″ is slidable relative to the support frame member 56. For instance, in one embodiment, the depth stop member 102″ may be at least partially received within a slot 122 of the support frame member 56 positioned below the wheel frame member 54 such that the depth stop member 102″ may slide relative to the support frame member 56. The support frame member 56A may further include a support projection 124 below the slot 122 for preventing rotation of the depth stop member 102″. The adjustment assembly 100′ may function in essentially the same way as the adjustment assembly 100 described with reference to FIGS. 2-6B. For instance, slidably moving the depth stop member 102″ varies the amount that the wheel frame member 54 is allowed to pivot before coming into contact with the depth stop member 102′, which, in turn, varies the vertical positioning of the cleaning wheel(s) 48 and thus, adjusts the lower height limit for the cleaning wheel(s) 48.

For instance, as shown in FIG. 7A, when the depth stop member 102″ is moved into a first translational position and a lower portion or surface of the wheel frame member 54 abuts against the depth stop member 102″, the cleaning wheel(s) 48 is at a minimum lower height setting along the vertical direction V1. Similarly, as shown in FIG. 7B, when the depth stop member 102″ is moved into a second translational position and a lower portion of the wheel frame member 54 abuts against the depth stop member 102″, the cleaning wheel(s) 48 is at a maximum lower height setting along the vertical direction V1. As such, varying the translational position of the depth stop member 102″ between the first and second translational positions generally varies the lower height limit within a range R3 defined between the minimum and maximum lower height settings. It should be appreciated that the portion of the wheel frame member 54 that abuts against the depth stop member 102″ changes with translation of the depth stop member 102″. For instance, the depth stop member 102″ contacts a portion of the wheel frame member 54 closer to the pivot point 58 when in the second translational position than in the first translational position.

Additionally, the actuator 104″ may be selectively controllable to slide the depth stop member 102′ relative to the support frame member 56 to adjust such lower height limit. For example, in the embodiment shown, the actuator 104″ includes a cylinder 126 (e.g., hydraulic, pneumatic, etc.) and a rod 128, with a first end of the rod 128 being slidably received within the cylinder 126 and a second end of the rod 128 being coupled to the depth stop member 102′. When the rod 128 extends and retracts relative to the cylinder 126, the depth stop member 102′ is slid with the rod 128, which adjusts the lower height limit. However, it should be appreciated that the actuator 104″ may be configured as any other suitable actuator for sliding the depth stop member 102′.

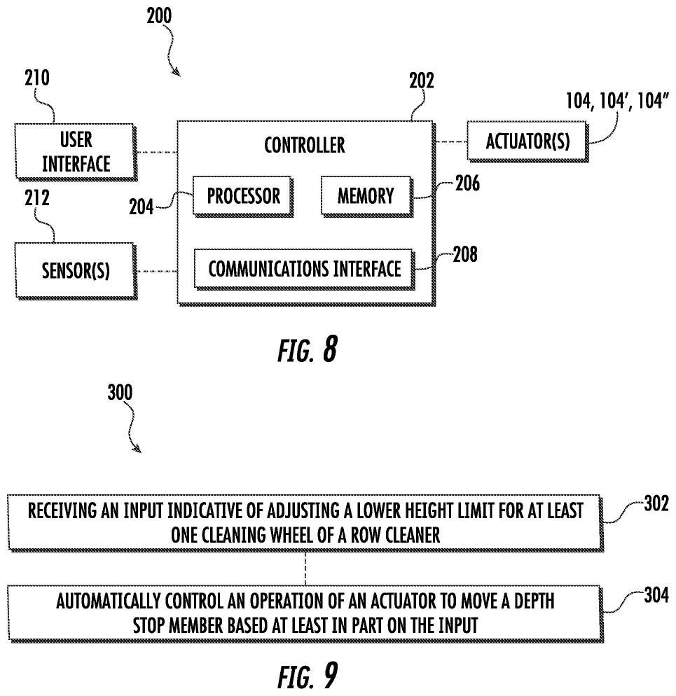

Referring now to FIG. 8, a schematic view of one embodiment of a system 200 for automatically adjusting a height limit of a row cleaner of an agricultural implement is illustrated in accordance with aspects of the present subject matter. In general, the system 200 will be described herein with reference to the implement 10 described above with reference to FIG. 1, the row unit 46 of FIG. 2, and the adjustment assemblies 100, 100′ described with reference to FIGS. 2-7B. However, it should be appreciated by those of ordinary skill in the art that the disclosed system 200 may generally be utilized with agricultural implements having any other suitable implement configuration, with row units having any other suitable assembly configuration, and/or with adjustment assemblies having any other suitable configuration. Additionally, it should be appreciated that, for purposes of illustration, communicative links or electrical couplings of the system 200 shown in FIG. 8 are indicated by dashed lines.

As shown in FIG. 8, the system 200 may include a controller 202 communicatively coupled to one or more components of the agricultural implement 10, such as one or more actuators (e.g., actuator(s) 104, 104′, 104″) used to actuate an associated depth stop member(s) (e.g., depth stop member(s) 102, 102′, 102″). Further, in some embodiments, the system 200 may be coupled to a user interface 210. The user interface 210 described herein may include, without limitation, any combination of input and/or output devices that allow an operator to provide inputs to the controller 202 and/or that allow the controller 202 to provide feedback to the operator, such as a keyboard, keypad, pointing device, buttons, knobs, touch sensitive screen, mobile device, audio input device, audio output device, and/or the like. Additionally, in some embodiments, the system 200 includes one or more sensors 212 that are used to detect one or more parameters associated with field conditions of a field (e.g., residue coverage, size, moisture content, soil type, clods, etc.).

In general, the controller 202 may include any suitable processor-based device known in the art, such as a computing device or any suitable combination of computing devices. Thus, in several embodiments, the controller 202 may include one or more processor(s) 204, and associated memory device(s) 206 configured to perform a variety of computer-implemented functions. As used herein, the term “processor” refers not only to integrated circuits referred to in the art as being included in a computer, but also refers to a controller, a microcontroller, a microcomputer, a programmable logic circuit (PLC), an application specific integrated circuit, and other programmable circuits. Additionally, the memory device(s) 206 of the controller 202 may generally comprise memory element(s) including, but not limited to, a computer readable medium (e.g., random access memory RAM)), a computer readable non-volatile medium (e.g., a flash memory), a floppy disk, a compact disk-read only memory (CD-ROM), a magneto-optical disk (MOD), a digital versatile disk (DVD) and/or other suitable memory elements. Such memory device(s) 206 may generally be configured to store suitable computer-readable instructions that, when implemented by the processor(s) 204, configure the controller 202 to perform various computer-implemented functions, such as one or more aspects of the methods and algorithms that will be described herein. In addition, the controller 202 may also include various other suitable components, such as a communications circuit or module, one or more input/output channels, a data/control bus and/or the like.

In several embodiments, the controller 202 may correspond to an existing controller of the implement 10 and/or an existing controller of a work vehicle configured to tow the implement 10. However, it should be appreciated that, in other embodiments, the controller 202 may instead correspond to a separate processing device. For instance, in one embodiment, the controller 202 may form all or part of a separate plug-in module that may be installed on the agricultural implement 10 or the work vehicle to allow for the disclosed system and method to be implemented without requiring additional software to be uploaded onto existing control devices of the work vehicle or the agricultural implement 10.

In some embodiments, the controller 202 may include a communications module or interface 208 to allow for the controller 202 to communicate with and/or electronically control any of the various system components described herein. For instance, one or more communicative links or interfaces (e.g., one or more data buses) may be provided between the communications interface 208 and the actuator(s) 104, 104′, 104″ to allow the controller 202 to control the operation of one or more components of the actuator(s) 104, 104′, 104″. Further, one or more communicative links or interfaces (e.g., one or more data buses) may be provided between the communications interface 208 and a user interface (e.g., user interface 210) to allow operator inputs to be received by the controller 202 and/or the allow the controller 202 to control the operation of one or more components of the user interface 210. Additionally, one or more communicative links or interfaces (e.g., one or more data buses) may be provided between the communications interface 208 and the sensor(s) 212 to allow data to be transmitted from the sensor(s) 212 to the controller 202.

As described above, the actuator(s) 104, 104′, 104″ may be selectively controllable to move the depth stop member(s) 102, 102′, 102″ to adjust a height limit (i.e., the lower height limit) of a row cleaner 46 of the agricultural implement 10. In one embodiment, the controller 202 may be configured to automatically control the operation of the actuator(s) 104, 104′, 104″ based at least in part on an input received from an operator (e.g., via the user interface 210) to adjust the lower height limit of the row cleaner(s) 46. For instance, the controller 202 may receive an operator input via the user interface 210 associated with raising or lowering the cleaning wheel(s) 48 and, in return, control the operation of the actuator(s) 104, 104′, 104″ to actuate the depth stop member(s) 102, 102′, 102″ to rotate accordingly. For example, if the input is associated with adjusting the lower height limit to raise the cleaning wheel(s) 48, the controller 202 may be configured to control the operation of the actuator(s) 104, 104′ to rotate the depth stop member(s) 102, 102′ towards the second rotational position (FIGS. 4B and 6B) and/or the operation of the actuator(s) 104″ to translate the depth stop member(s) 102″ towards the second translational position (FIG. 7B). Similarly, if the input is associated with adjusting the lower height limit to lower the cleaning wheel(s) 48, the controller 202 may be configured to control the operation of the actuator(s) 104, 104′ to rotate the depth stop member(s) 102, 102′ towards the first rotational position (FIGS. 4A and 6A) and/or the operation of the actuator(s) 104″ to translate the depth stop member(s) 102″ towards the first translational position (FIG. 7A). The user interface 210 may be configured in any suitable way to allow the operator input to indicate the desired change in the lower height limit. For instance, the user interface 210 may include inputs for raising or lowering the cleaning wheel(s) 48 in discrete increments or continuously, and/or inputs for different predetermined settings for the lower height limit within the given range (e.g., range(s) R1, R2, R3).

In some embodiments, the controller 202 may be configured to actively control the operation of the actuator(s) 104, 104′, 104″ based at least in part on data indicative of field conditions. For instance, when there is more residue, larger residue and/or clods, and/or more moisture in an area of the field, it may be beneficial to actively adjust the lower height limit such that the cleaning wheel(s) 48 are positioned lower at the lower height limit and, vice versa, when there is less residue, smaller residue and/or clods, and/or less moisture in an area of the field, it may be beneficial to actively adjust the lower height limit such that the cleaning wheel(s) 48 are positioned higher at the lower height limit. In one embodiment, the controller 202 may be configured to receive the data indicative of the field conditions (e.g., residue coverage, residue and/or clod size, and/or moisture content within the field) from the sensor(s) 212. The sensor(s) 212 may be mounted at any suitable location on the implement 10 (e.g., to the implement frame assembly 22, the row unit frame(s) 24, and/or the like) or the work vehicle towing the implement 10 to generate data indicative of the monitored field conditions as the implement 10 is moved across the field. However, it should be appreciated that the controller 202 may be configured to receive data indicative of the monitored field conditions from any other suitable source. For instance, in some embodiments, the data indicative of the monitored field conditions may be historical data generated during a previous agricultural operation within the field (e.g., a harvesting operation).

The sensor(s) 212 may include any suitable type of sensing device(s) for generating data indicative of the monitored field conditions (e.g., images, point cloud data, and/or the like). For example, in several embodiments, the sensor(s) 212 may correspond to a camera(s) (e.g., RGB, multispectral, infrared, thermal, etc.). In some embodiments, the sensor(s) 212 may correspond to an infrared sensor(s), a radar sensor(s), a Light Detection and Ranging (LIDAR) sensor(s), etc. However, in alternative embodiments, the sensor(s) 212 may correspond to any other suitable device(s) or combination of devices. The controller 202 may include any suitable data processing techniques to determine the field conditions within the field based at least in part on the data received from the sensor(s) 212. In some embodiments, for example, the controller 202 may analyze images of the field using any suitable image processing techniques. Suitable processing or analyzing techniques may include performing a spatial or spectral analysis on received images or image data. For instance, geometric or spatial processing algorithms may differentiate the shape and/or average size of residue from soil particles. Similarly, shape detection and/or edge-finding or perimeter-finding algorithms may be used that differentiate clods from soil and/or residue. Additionally, if the sensor(s) 212 comprises a multi-spectral camera(s), spectral processing algorithms may be used to differentiate the spectral reflectance of residue from the spectral reflectance of soil and/or to estimate the moisture content of the field.

The controller 202 may further be configured to compare the field conditions detected within the field based on the data received from the sensor(s) 212 to one or more thresholds to determine an appropriate lower height limit for the cleaning wheel(s) 48. For example, when the controller 202 determines that the residue coverage, residue and/or clod size, and/or moisture content within the field exceeds a maximum associated threshold(s), the controller 202 may automatically control the operation of the actuator(s) 104, 104′, 104″ to rotate the depth stop member(s) 102, 102′, 102″ such that the lower height limit for the cleaning wheel(s) 48 is lowered along the vertical direction. Similarly, when the controller 202 determines that the residue coverage, residue and/or clod size, and/or moisture content within the field falls below a minimum associated threshold(s), the controller 202 may automatically control the operation of the actuator(s) 104, 104′, 104″ to rotate the depth stop member(s) 102, 102′, 102″ such that the lower height limit for the cleaning wheel(s) 48 is raised along the vertical direction. It should be appreciated that the controller 202 may be configured to compare the field conditions to any suitable number of thresholds. Further, it should be appreciated that, in some embodiments, such thresholds may be predetermined and stored within the memory 206 of the controller 202. Additionally, it should be appreciated that any other suitable field conditions may be used to adjust the lower height limit.

It should additionally be appreciated that the actuator(s) 104, 104′, 104″ of multiple row units 18 may be controlled individually to set different lower height limits for different row cleaners 46. Alternatively, or additionally, one or more of the actuator(s) 104, 104′, 104″ of multiple row units 18 may be controlled together so that the lower height limit is the same for each row unit 18 within such grouping.

As described, the system 200 allows for a more efficient way to automatically adjust the lower height limit of one or more row cleaners 46 at a time based on operator input, which improves the overall efficiency of a seed planting operation. Such system 200 also allows for active automatic adjustment of the lower height limit of one or more row cleaners 46 at a time based on the determined field conditions, which improves the overall effectiveness of the row cleaner(s) 46.

Referring now to FIG. 9, a flow diagram of one embodiment of a method 300 for automatically adjusting a height limit of a row cleaner of an agricultural implement is illustrated in accordance with aspects of the present subject matter. In general, the method 300 will be described herein with reference to the implement 10 described above with reference to FIG. 1, the row unit 46 of FIG. 2, the adjustment assemblies 100, 100″ described with reference to FIGS. 2-7B, and the system 200 described with reference to FIG. 8. However, it should be appreciated by those of ordinary skill in the art that the disclosed method 300 may be implemented with agricultural implements having any other suitable implement configuration, with row units having any other suitable assembly configuration, with adjustment assemblies having any other suitable configuration, and/or with systems having any other suitable system configuration. In addition, although FIG. 9 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 9, at (302), the method 300 may include receiving an input associated with adjusting a lower height limit for at least one cleaning wheel of a row cleaner. For instance, as described above, the input may be an operator input received by the controller 202 (e.g., via the user interface 210) that is associated with a request to adjust (e.g., increase or decrease) the lower height limit of the cleaning wheel(s) 48 of a row cleaner 46. Alternatively, or additionally, the input received by the controller 202 may be data indicative of a field condition(s) within a field which is, in turn, indicative of a need to adjust (e.g., increase or decrease) the lower height limit.

Additionally, at (304), the method 300 may include automatically controlling an operation of an actuator to move a depth stop member based at least in part on the input to adjust the lower height limit for the at least one cleaning wheel. For instance, as indicated above, the controller 202 may be configured to automatically control the operation of the actuator(s) 104, 104′, 104″ to move (e.g., rotate or slide) the depth stop member(s) 102, 102′, 102″ based on the received input to adjust (e.g., increase or decrease) the lower height limit.

It is to be understood that the steps of the method 300 are performed by the computing system 200 upon loading and executing software code or instructions which are tangibly stored on a tangible computer readable medium, such as on a magnetic medium, e.g., a computer hard drive, an optical medium, e.g., an optical disk, solid-state memory, e.g., flash memory, or other storage media known in the art. Thus, any of the functionality performed by the computing system 200 described herein, such as the method 300, is implemented in software code or instructions which are tangibly stored on a tangible computer readable medium. The computing system 200 loads the software code or instructions via a direct interface with the computer readable medium or via a wired and/or wireless network. Upon loading and executing such software code or instructions by the computing system 200, the computing system 200 may perform any of the functionality of the computing system 200 described herein, including any steps of the method 300 described herein.

The term “software code” or “code” used herein refers to any instructions or set of instructions that influence the operation of a computer or computing system. They may exist in a computer-executable form, such as machine code, which is the set of instructions and data directly executed by a computer's central processing unit or by a computing system, a human-understandable form, such as source code, which may be compiled in order to be executed by a computer's central processing unit or by a computing system, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a computing system.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A system for adjusting a height limit of a row cleaner of a row unit of an agricultural implement, comprising:
a first frame member coupled to a support structure of a row unit of an agricultural implement;
a second frame member rotatable relative to the first frame member;
at least one cleaning wheel rotatable relative to the second frame member;
a depth stop member movably coupled to the first frame member, the depth stop member configured to set a lower height limit for the at least one cleaning wheel, the second frame member configured to abut against the depth stop member when the at least one cleaning wheel is disposed at the lower height limit;
an actuator controllable to move the depth stop member relative to the first frame member to adjust the lower height limit; and
a controller configured to selectively control an operation of the actuator to set the lower height limit.

2. The system of claim 1, wherein the depth stop member is rotatably coupled to the first frame member about a rotational axis, the depth stop member defining a contact surface against which the second frame member abuts when the at least one cleaning wheel is disposed at the lower height limit,
wherein the actuator is selectively controllable to rotate the depth stop member about the rotational axis to adjust the lower height limit of the at least one cleaning wheel.

3. The system of claim 2, wherein the depth stop member is rotatable between a first rotational position and a second rotational position, the second frame member abutting against a first portion of the contact surface when the depth stop member is in the first rotational position and a second portion of the contact surface when the depth stop member is in the second rotational position, the first portion of the contact surface being spaced apart from the rotational axis by a first distance, and the second portion of the contact surface being spaced apart from the rotational axis by a second distance, the first distance differing from the second distance.

4. The system of claim 3, wherein the lower height limit is variable with rotation of the depth stop member between a minimum lower height setting for the lower height limit and a maximum lower height setting for the lower height limit,
wherein the lower height limit is equal to the minimum lower height setting when the depth stop member is in the first rotational position, and
wherein the lower height limit is equal to the maximum lower height setting when the depth stop member is in the second rotational position.

5. The system of claim 2, wherein the actuator comprises a rotary actuator or a linear actuator.

6. The system of claim 1, wherein the depth stop member is slidably coupled to the first frame member, wherein the actuator is selectively controllable to slide the depth stop member relative to the first frame member.

7. The system of claim 1, wherein the depth stop member is slidable between a first position and a second position such that the lower height limit varies between a minimum lower height setting for the lower height limit and a maximum lower height setting for the lower height limit as the depth stop member slides between the first and second positions,
wherein the lower height limit is equal to the minimum lower height setting when the depth stop member is in the first position, and
wherein the lower height limit is equal to the maximum lower height setting when the depth stop member is in the second position.

8. The system of claim 1, wherein a lower surface of the second frame member along a vertical direction is configured to abut against the depth stop member when the at least one cleaning wheel is disposed at the lower height limit.

9. An agricultural implement, comprising:
a frame;
a row unit supported by the frame, the row unit being configured to work a field as the implement is moved across the field, the row unit comprising:
a first frame member coupled to a support structure of the row unit;
a second frame member rotatable relative to the first frame member;
at least one cleaning wheel rotatable relative to the second frame member; and
a depth stop member movably coupled to the first frame member, the depth stop member configured to set a lower height limit for the at least one cleaning wheel, the second frame member configured to abut against the depth stop member when the at least one cleaning wheel is disposed at the lower height limit.

10. The agricultural implement of claim 9, wherein the depth stop member is rotatably coupled to the first frame member about a rotational axis, the depth stop member defining a contact surface against which the second frame member abuts when the at least one cleaning wheel is disposed at the lower height limit,
wherein the depth stop member is rotatable about the rotational axis to adjust the lower height limit of the at least one cleaning wheel.

11. The agricultural implement of claim 10, wherein the depth stop member is rotatable between a first rotational position and a second rotational position, the second frame member abutting against a first portion of the contact surface when the depth stop member is in the first rotational position and a second portion of the contact surface when the depth stop member is in the second rotational position, the first portion of the contact surface being spaced apart from the rotational axis by a first distance, and the second portion of the contact surface being spaced apart from the rotational axis by a second distance, the first distance differing from the second distance.

12. The agricultural implement of claim 11, wherein the lower height limit is variable with rotation of the depth stop member between a minimum lower height setting for the lower height limit and a maximum lower height setting for the lower height limit,
wherein the lower height limit is equal to the minimum lower height setting when the depth stop member is in the first rotational position, and
wherein the lower height limit is equal to the maximum lower height setting when the depth stop member is in the second rotational position.

13. The agricultural implement of claim 9, wherein the depth stop member is slidably coupled to the first frame member, wherein the depth stop member is slidable relative to the first frame member to adjust the lower height limit of the at least one cleaning wheel.

14. The agricultural implement of claim 13, wherein the depth stop member is slidable between a first position and a second position such that the lower height limit varies between a minimum lower height setting for the lower height limit and a maximum lower height setting for the lower height limit as the depth stop member slides between the first and second positions,
wherein the lower height limit is equal to the minimum lower height setting when the depth stop member is in the first position, and
wherein the lower height limit is equal to the maximum lower height setting when the depth stop member is in the second position.

15. The agricultural implement of claim 9, wherein a lower surface of the second frame member along a vertical direction is configured to abut against the depth stop member when the at least one cleaning wheel is disposed at the lower height limit.

16. The agricultural implement of claim 9, further comprising an actuator controllable to move the depth stop member relative to the first frame member to adjust the lower height limit; and
a controller configured to selectively control an operation of the actuator to set the lower height limit.

17. A method for automatically adjusting a height limit of a row cleaner of a row unit of an agricultural implement, the row cleaner comprising a first frame member coupled to a support structure of the row unit, a second frame member rotatable relative to the first frame member, at least one cleaning wheel rotatable relative to the second frame member, and a depth stop member movably coupled to the first frame member, the method comprising:
receiving, by one or more computing devices, an input associated with adjusting a lower height limit for the at least one cleaning wheel, the lower height limit being set by the depth stop member; and
automatically controlling, with the one or more computing devices, an operation of an actuator to move the depth stop member based at least in part on the input to adjust the lower height limit for the at least one cleaning wheel.

18. The method of claim 17, wherein the input is received from an operator via a user interface.

19. The method of claim 17, wherein the input comprises data indicative of residue coverage within a field that the agricultural implement is moving across.

20. The method of claim 19, wherein automatically controlling the operation of the actuator comprises automatically controlling the operation of the actuator to move the depth stop member such that the lower height limit is lowered along a vertical direction when the residue coverage within the field exceeds a threshold.
